(19) United States
(12) Patent Application Publication
(10) Pub. No.: US 2016/0112241 A1
(43) Pub. Date: Apr. 21, 2016

(54) INSTANT MESSENGER APPLICATIONS FOR INTERACTING WITH NETWORK INFRASTRUCTURE DEVICES

(71) Applicant: Meru Networks, Sunnyvale, CA (US)

(72) Inventor: Anil KAUSHIK, Bangalore (IN)

(73) Assignee: Meru Networks, Sunnyvale, CA (US)

(21) Appl. No.: 14/515,506

(22) Filed: Oct. 15, 2014

(51) Int. Cl. H04L 12/24

(52) U.S. Cl. CPC H04L 41/026; H04L 41/048; H04L 41/28

(57) ABSTRACT

Interaction with network infrastructure devices using instant messenger applications is disclosed. A message is received on an instant messenger application executing on the network infrastructure device. The message is sent from an authorized party or instant messenger friend. The message is mapped to one or more commands recognized by an operating system of the network infrastructure. Commands are submitted on a command line interface. A response to the one or more commands from the network infrastructure device is received on the command line interface. The response is sent on the instant messenger to the authorized party.

### FIELD OF THE INVENTION

The invention relates generally to wireless computer networking, and more specifically, interacting with network infrastructure devices using instant messenger applications.

### BACKGROUND

Many LANs (Local Access Networks) operate 24-hours a day, performing batch operations and back-ups at non-peak hours, in addition to peak hour operations. Consequently, problems with devices critical to network operations need to be constantly monitored.

However, small organizations often cannot afford an on-site network administrator to always be on duty. Moreover, burgeoning remote working situations have reduced the amount of time that IT professionals are on-site, and many network tasks require a direct serial connection to a device for diagnostics and repair. As a result, LANs are vulnerable extended downtimes and poor performance when a network admin is away from a traditional computing environment for adjusting network provisioning.

What is needed is a robust technique to interact with network infrastructure devices remotely using instant messenger applications.

### SUMMARY

These shortcomings are addressed by the present disclosure of methods, computer program products, and systems for interacting with network infrastructure devices using instant messenger applications.

In one embodiment, a (natural language) message is received on an instant messenger application executing on the network infrastructure device. The message sent from an authorized party or instant messenger friend. The message is mapped to one or more commands recognized by an operating system of the network infrastructure. Natural language communications with informal messages are processed to expose direct commands for monitoring, provisioning, and adjusting. The one or more commands is submitted on a command line interface.

In an embodiment, a response to the one or more commands from the network infrastructure device is received on the command line interface. The response is sent on the instant messenger to the authorized party.

Advantageously, network devices can be monitored and adjusted through remotely-available and convenient interfaces. Additionally, natural language interaction opens up network maintenance to regular employees without IT training.

### BRIEF DESCRIPTION OF THE DRAWINGS

In the following drawings, like reference numbers are used to refer to like elements. Although the following figures depict various examples of the invention, the invention is not limited to the examples depicted in the figures.

FIG. 1 is a high-level block diagram illustrating a system to interact with network infrastructure devices with instant messenger applications, according to one embodiment.

FIG. 2 is a more detailed block diagram illustrating an instant messenger module of the system of FIG. 1, according to one embodiment.

FIG. 3 is a block diagram illustrating a data path for a network admin initiating interaction with network infrastructure devices using an instant messenger application, according to one embodiment.

FIG. 4 is a high-level flow diagram illustrating a method for a network admin initiating interaction with network infrastructure devices using an instant messenger application, according to one embodiment.

FIG. 5 is a block diagram illustrating a data path for a network infrastructure device initiating interaction with network admin using an instant messenger application, according to one embodiment.

FIG. 6 is a high-level flow diagram illustrating a method for a network infrastructure device initiating interaction with a network admin using an instant messenger application, according to one embodiment.

FIG. 7 is a block diagram illustrating a data path for a controller initiating interaction with an access point using an instant messenger application, according to one embodiment.

FIGS. 8A and B are high-level flow diagram illustrating methods for a controller initiating interaction with an access point using an instant messenger application, according to one embodiment.

FIG. 9 is a block diagram illustrating an exemplary computing device, according to one embodiment.

### DETAILED DESCRIPTION

The present invention provides methods, computer program products, and systems for interacting with network infrastructure devices using instant messenger applications. An instant messenger application (e.g. Microsoft Lync) can send real-time or delayed messages between peer client applications. One of ordinary skill in the art will recognize that many other scenarios are possible, as discussed in more detail below. For example, although the description herein refers to instant messenger applications, other communication software or combinations thereof, such as SMS messaging applications or Twitter applications, can be substituted to send messages.

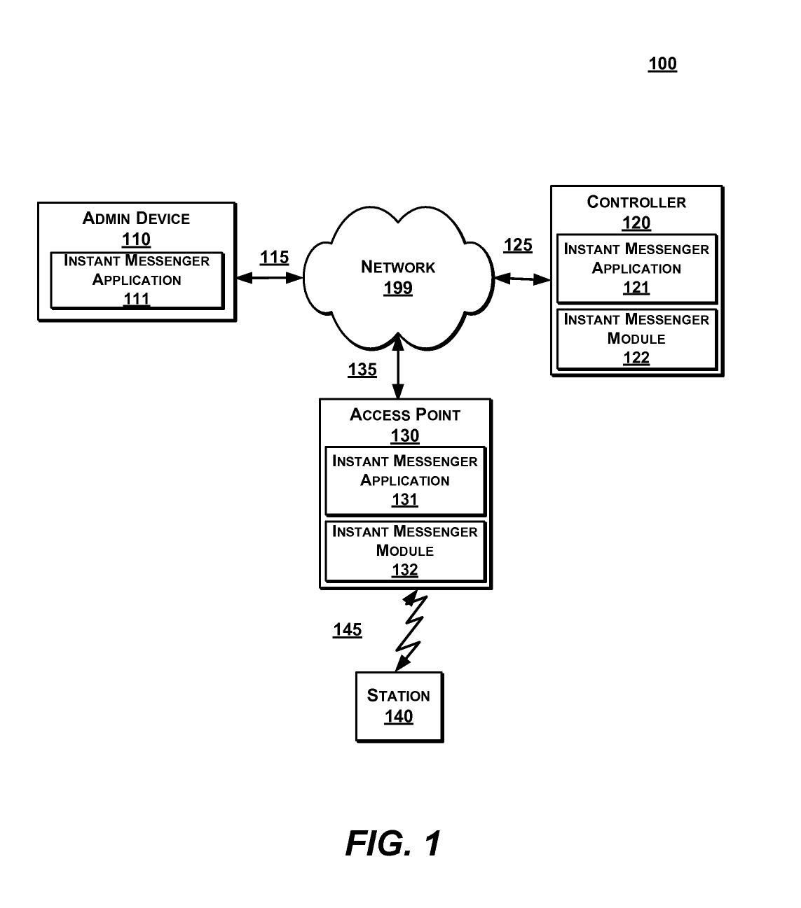

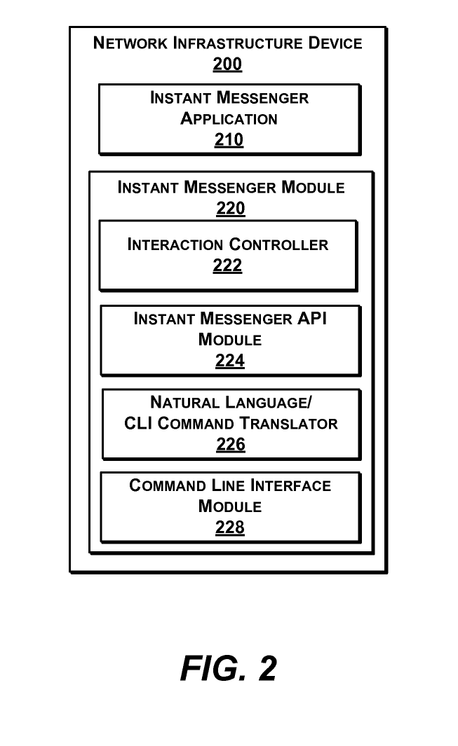

Systems to Interact with a Network Infrastructure Device Using an Instant Messenger Applications (FIG. 1-2)

FIG. 1 is a high-level block diagram illustrating a system 100 to interact with network infrastructure devices using instant messenger applications, according to one embodiment. The system 100 comprises admin device 110, controller 120, access point 130, and station 140. The components can be coupled to a network 199, such as the Internet, a local network or a cellular network, through any suitable wired (e.g., Ethernet) or wireless (e.g., Wi-Fi or 4G) medium, or hybrid combination of network types. In a preferred embodiment, the controller 120, and the access point 130 are coupled to the network 199 through wired communication channels 125, 135. Station 140 is coupled to the access point 130 through wireless communication channel 145 and admin device 110 can be coupled to any of the components through any type of communication channel.

Other embodiments of communication channels for system 100 are possible. Additional network components can also be part of the system 100, such as additional controllers (e.g., an SDN, or software-defined networking, controller), additional access points or only one access point, firewalls, virus scanners, routers, switches, application servers, databases, and the like.

The admin device 110 can be used by network administrators or business owners to manage the system 100 using an instant messenger application 111 executing on a processor. In one embodiment, a network admin uses a smartphone from a remote location to check for any troubled devices that are responsible for providing network services within the network infrastructure by typing “status check” into the instant messenger application 111. In another embodiment, a network admin uses natural language to interact with the controller 120 by stating “how are things going” into a Bluetooth microphone while driving. The captured audio is processed by voice recognition software and automatically input into the instant messenger application 111. In response, a voice responds “not too good, many stations are losing connection due to heavy traffic.” Finally, additional network resources are provisioned by stating “please add additional bandwidth.” Many other variations are possible.

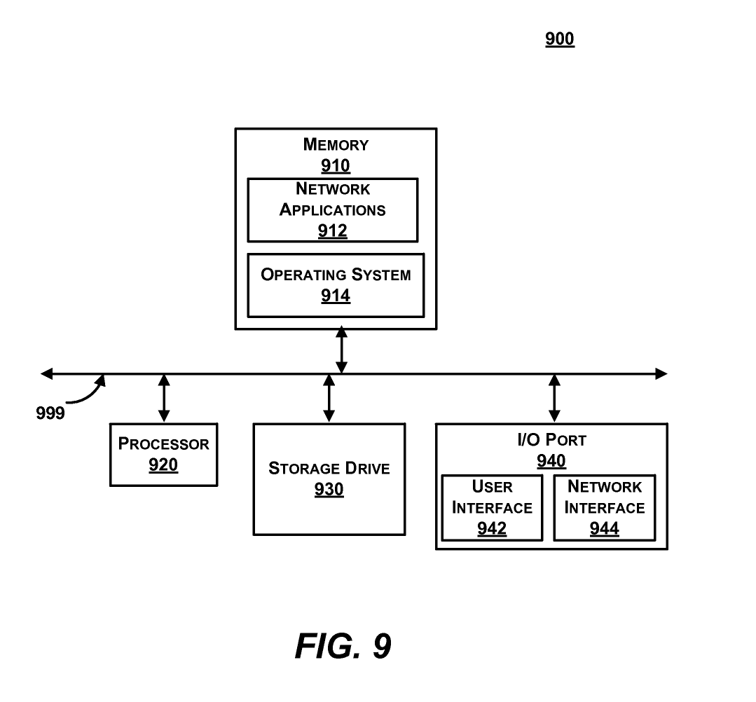

The admin device 110 can be a smart phone, a tablet, a phablet, a laptop or any other processor driven device in communication with the system 100 (see e.g., FIG. 9). In one embodiment, the admin device 110 is the station 130.

The controller 120, in one embodiment, has an instant messenger module 122 to detect incoming messages from authorized users of an instant messenger application 121, and implement commands embedded therein. The commands can be explicitly commands (e.g., CLI, or Command Line Interface, commands or operating system) or natural language directives that are translated to commands and then sent to a CLI or other operating system interface or network application. Once a response is available, the controller 120 traces back the incoming path by returning CLI output directly or as natural language (either as text or a voice audio file). The controller 120, in another embodiment, initiates an instant message to report network conditions in general or as associated with a particular network infrastructure device. The controller 120, in yet another embodiment, sends or receives device initiated instant messages, for example, for a self-provisioning system.

The controller 120 can receive commands specific to normal operations of managing multiple access points (e.g., the access point 130). For example, virtual cell and virtual port modes can be toggled on and off and optimized using the same commands of a network admin connected to the controller 120 through a serial port or some other manner. Virtual cell refers to a mode in which more than one access point shares a common BSSID (Basic Service Set Identifier) so that stations moving between those access points do not need to reconfigure with a new BSSID. Virtual port refers to a mode in which an individual station is assigned a unique and persistent BSSID for granular control of behavior of the station while connected. More specifically, the controller 120 can receive a message querying “number of new virtual port connections within the last half hour” to which the controller 120 responds.

The controller 120 can be implemented in any of the computing devices discussed herein (e.g., see FIG. 9). For example, the controller 120 can be an MC1500 or MC6000 device by Meru Networks of Sunnyvale, Calif. Additional embodiments of the controller 120 are discussed with respect to the generic network infrastructure device of FIG. 2.

The access point 130 also includes an instant messenger application 131 to receive commands processed by an instant messenger module 132. The commands can be general and also can specifically concern operations of the access point 130 in providing network connectivity to the station 140 and other wireless devices. For example, after responding with a status on processor load and a number of stalled beacons (i.e., failed beacon broadcasts), an instant message is received for configuring longer cycles for beacons in order to ease the processor load and prevent stalled beacons.

The access point 130 can be individually implemented as a server blade, a personal computer, a laptop, a smartphone with tethering services, any appropriate processor-driven device, or any of the computing devices discussed herein (e.g., see FIG. 9). The access point 130 can be specifically configured for object advertising or be generically configured. For example, the access point 130 can be an AP 110 or AP 433 (modified as discussed herein) by Meru Networks of Sunnyvale, Calif. A network administrator can strategically place the access point 130 for optimal coverage area over a locale. The access point 130 can, in turn, be connected to a wired hub, switch or router connected to the network 199. In another embodiment, the functionality is incorporated into a switch or router. More detailed embodiments of the access point 130 are covered by the generic network infrastructure device are discussed below in association with FIG. 2.

The station 140 can be individually implemented as a personal computer, a laptop computer, a tablet computer, a smart phone, a mobile computing device, a server, a cloud-based device, a virtual device, an Internet appliance, or any of the computing devices described herein (see e.g., FIG. 9). The station 140 connect to the access point 130 for access to a LAN or external networks using an RF (radio frequency) antenna and network software complying with, for example, IEEE 802.11 (promulgated by the Institute of Electrical and Electronics Engineers).

FIG. 2 is a more detailed block diagram illustrating a representative network infrastructure device 200, according to one embodiment. The network infrastructure device 200 includes an instant messenger application 210 and an instant messenger module 220. The components can be implemented in hardware, software, or a combination of both.

The instant messenger application 210 sends and receives messages originating from various sources (e.g., network users, network admins, self or other network infrastructure devices). Messages can be text, pictures, video, and include attachments such as scripts or software for installation. In some embodiments, messages are direct commands (e.g., CLI commands), and in other embodiments, messages are natural language from which direct commands can be derived. The instant messenger 210 can be a client that is downloaded from the Internet for local execution, or accessed through a web browser for cloud-execution. The instant messenger application 210 can be a stand-alone application or be integrated with other applications, such as a social network. Examples include Microsoft Lync, Yahoo! Messenger, Google Hangouts, Facebook Messenger, and others.

The instant messenger module 220 further comprises an interaction controller 222 to detect instant messages or CLI output and calls appropriate components for processing. In more detail, an instant messenger API (Application Programming Interface) module 224 interfaces to the instant messenger application 210 for checking to see if messages are received and from whom, and for sending messages to certain users. A natural language/CLI command translator 226 interprets the intent of messages akin to conversation between people, and maps the message to CLI commands or other commands that are executable by an operating system. Conversely, CLI commands can be translated to informal messages. Finally, the command line interface module 228 presents identified commands for processing by the network infrastructure device 200, and also receives output the CLI application.

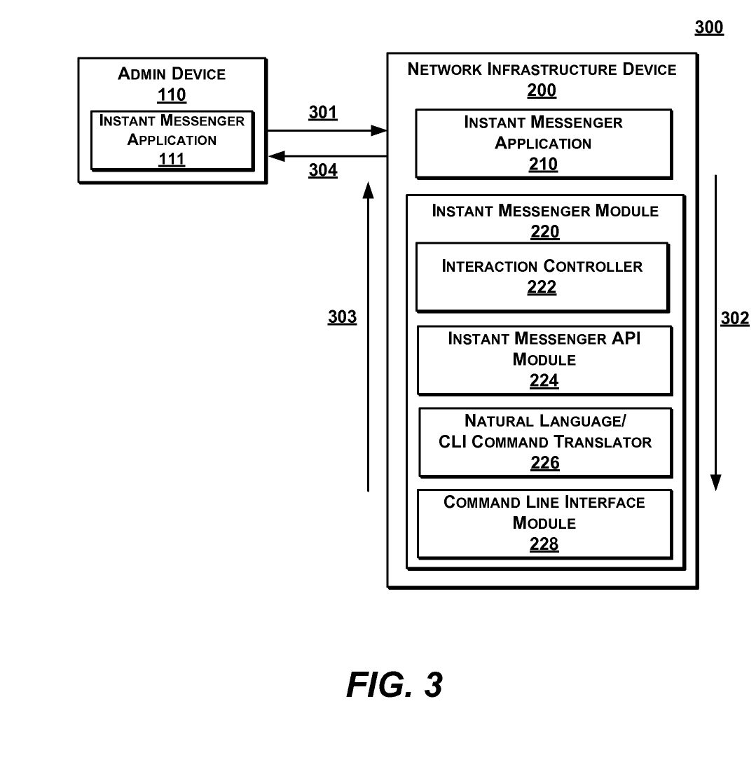

Methods for Interacting with a Network Infrastructure Device Using an Instant Messenger Application (FIG. 3-8)

FIG. 3 is a block diagram illustrating a data path 300 for a network admin initiating interaction with network infrastructure devices using an instant messenger application, according to one embodiment.

In more detail, the admin device 110 sends an instant message to the network infrastructure device 200 (interaction 301) and receives a response after processing (interaction 304). In more detail, the natural language message is pulled by the interaction controller 222 using the instant messenger module 224 for the natural language/CLI command translator 226. Mapped commands from the natural language message are sent from the natural language/CLI command translator 226 and resulting CLI commands are sent to the command line interface module 228 for processing by an operating system (interaction 302).

The command output is pulled by the interaction controller 222 from the command line interface module 228 to the natural language/CLI command translator 226. Resulting natural language is then sent to the instant messenger API module 224 for placement on the instant messenger application 210 (interaction 303) and transmission (interaction 304).

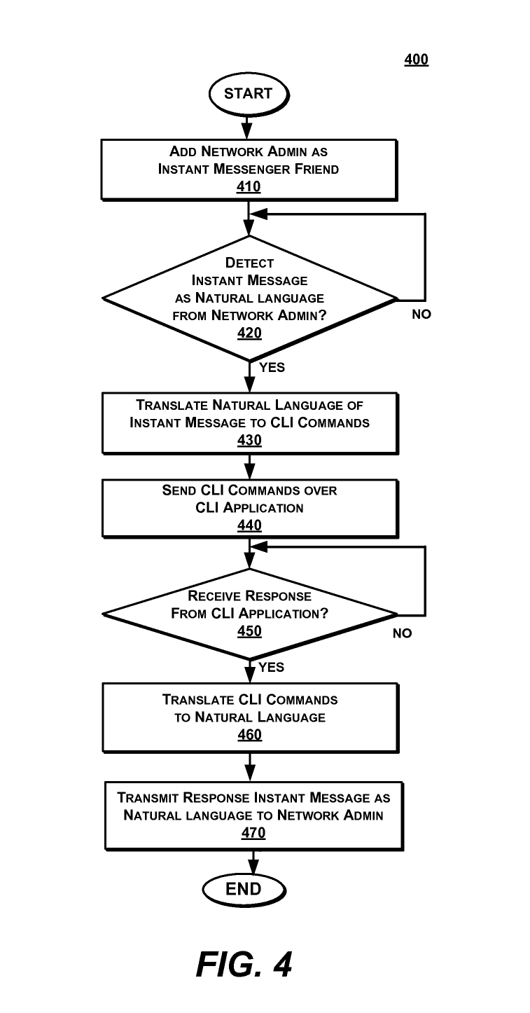

FIG. 4 is a high-level block diagram illustrating a method 400 for a network admin initiating interaction with network infrastructure devices using an instant messenger application, according to one embodiment.

A network admin is added as an instant messenger friend (step 410). Responsive to detecting an instant message as natural language from the network admin (step 420), the natural language is translated to CLI commands (step 430) which are then submitted to the operating system for execution (step 440). After a command response is received from the CLI application (step 450), a more information natural language term or phrase is synthesized (step 460) which is then back to the network admin (step 470).

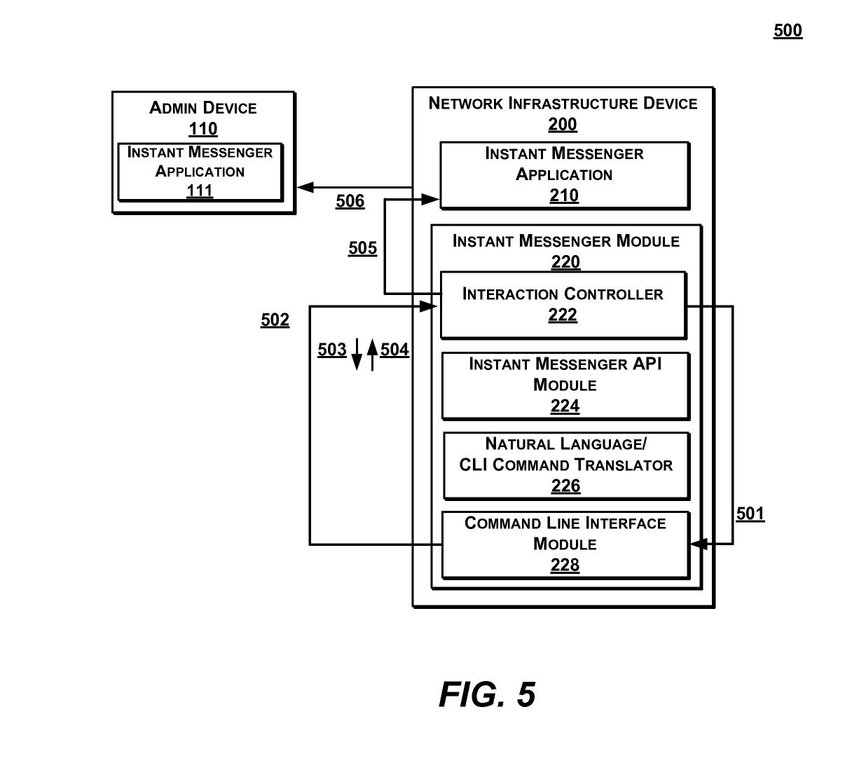

FIG. 5 is a block diagram illustrating a data path 500 for a network infrastructure device initiating interaction with network admin using an instant messenger application, according to one embodiment. After polling by the interaction controller 222 (interaction 501), the command line interface module 228 sends a command response to an interaction controller 222 (interaction 502) that is formatted (interactions 503, 504) for submission to the instant messenger application 210 (interaction 505). Interpretation of natural language may not be needed in a requirement in software-to-software communications.

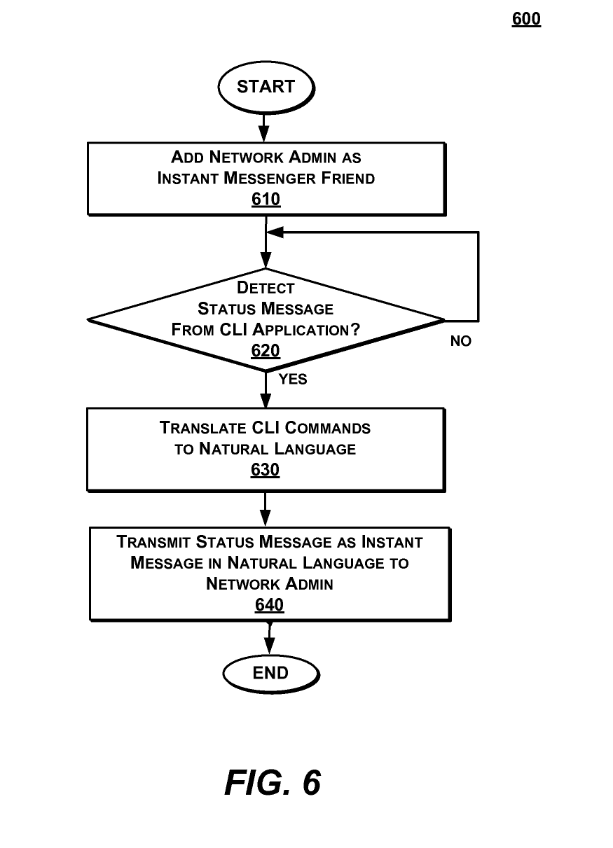

FIG. 6 is a high-level block diagram illustrating a method 600 for a network infrastructure device initiating interaction with a network admin using an instant messenger application, according to one embodiment.

A network admin is added as an instant messenger friend (step 610). Responsive to detecting a status message from the CLI application (step 620), the CLI command is translated to natural language (step 630), which are then submitted for transmission as an instant message to a network admin (step 640).

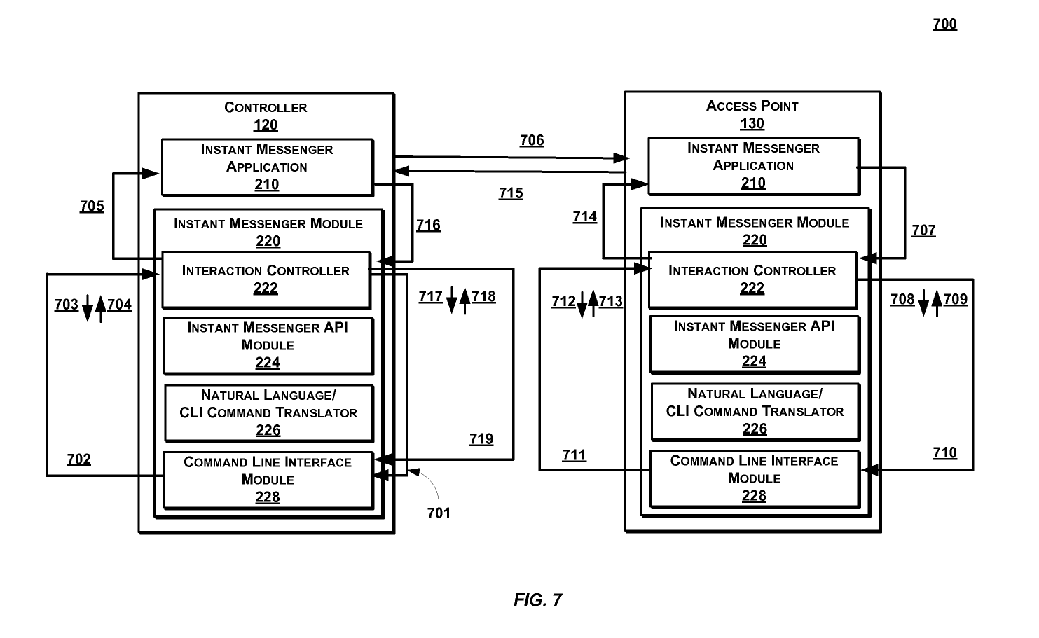

FIG. 7 is a block diagram illustrating a data path 700 for a controller initiating interaction with an access point using an instant messenger application, according to one embodiment.

The interaction controller 222 of the controller 120 pings the command line interface module 228 (interaction 701) and sends a command for an access point 120 to the interaction controller 222 (interaction 702). APIs are retrieved from the instant messenger API module 224 (interactions 703, 704) in order to submit the output to the instant messenger application 210 (interaction 705) for submission to an access point 130 as an instant message (interaction 706).

The access point 130 returns a command response to the controller 120 (interaction 715) after processing. To process, a message from the instant messenger application 330 is sent to the interaction controller 222 (interaction 707), which confers with the instant messenger API module 224 in order to expose the command (interactions 708, 709). Then, the interaction controller sends pings or other status checking mechanisms to the command line interface module (interaction 710). Interpretation of natural language may not be needed in a requirement in software-to-software communications. The command line interface module 228 sends a command response to an interaction controller (interaction 711) for submission to the instant messenger application 210 (interaction 714) after APIs are received (interaction 712, 713).

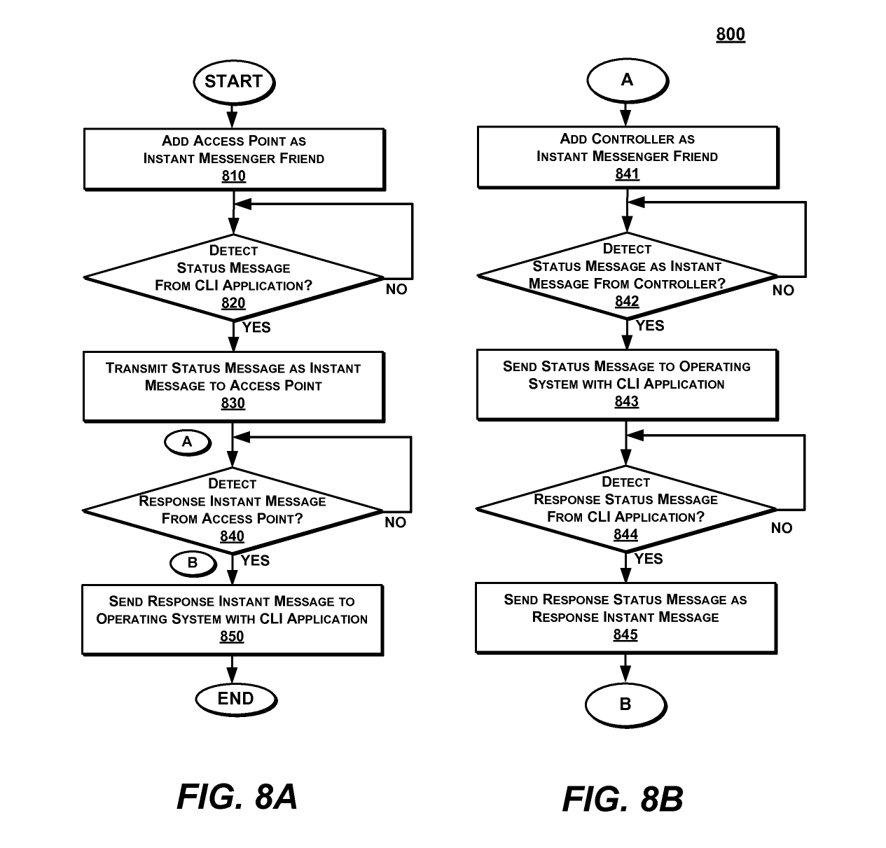

FIG. 8A is a high-level block diagram illustrating a method 800 for a controller initiating interaction with an access point using an instant messenger application, according to one embodiment.

To configure the controller, the access point is added as an instant messenger friend at the controller (step 810). A status message is detected from a CLI application (step 820). The status message is transmitted as an instant message to the access point (step 830). When a response to the instant message is detected from the access point (step 840), a response instant message is sent to the operating system using the CLI application (step 850).

Turning to provide more detail about processing in FIG. 8B, the message at the access point (step 840), the controller has been previously added as an instant messenger friend (step 841). The detected message (step 842) is sent as a status message to the operating system using a CLI application (step 843). When the response to status message is detected from the CLI application (step 844), a response status message is sent as a response instant message to the controller (step 845).

Generic Computing Device (FIG. 9)

FIG. 9 is a block diagram illustrating an exemplary computing device 900 for use in the system 100 of FIG. 1, according to one embodiment. The computing device 900 is an exemplary device that is implementable for each of the components of the system 100, including the admin device 110, the controller 120 and the access point 130. The computing device 900 can be a mobile computing device, a laptop device, a smartphone, a tablet device, a phablet device, a video game console, a personal computing device, a stationary computing device, a server blade, an Internet appliance, a virtual computing device, a distributed computing device, a cloud-based computing device, or any appropriate processor-driven device.

The computing device 900, of the present embodiment, includes a memory 910, a processor 920, a storage drive 930, and an I/O port 940. Each of the components is coupled for electronic communication via a bus 999. Communication can be digital and/or analog, and use any suitable protocol.

The memory 910 further comprises network applications 912 and an operating system 914. The network applications 920 can be the instant messenger application 200 and/or the instant messenger module 220 of FIG. 2). Other network applications 912 can include a web browser, a mobile application, an application that uses networking, a remote application executing locally, a network protocol application, a network management application, a network routing application, or the like.

The operating system 914 can be one of the Microsoft Windows® family of operating systems (e.g., Windows 95, 98, Me, Windows NT, Windows 2000, Windows XP, Windows XP x64 Edition, Windows Vista, Windows CE, Windows Mobile, Windows 9 or Windows 8), Linux, HP-UX, UNIX, Sun OS, Solaris, Mac OS X, Alpha OS, AIX, IRIX32, or IRIX64. Other operating systems may be used. Microsoft Windows is a trademark of Microsoft Corporation.

The processor 920 can be a network processor (e.g., optimized for IEEE 802.11), a general purpose processor, an application-specific integrated circuit (ASIC), a field programmable gate array (FPGA), a reduced instruction set controller (RISC) processor, an integrated circuit, or the like. Qualcomm Atheros, Broadcom Corporation, and Marvell Semiconductors manufacture processors that are optimized for IEEE 802.11 devices. The processor 920 can be single core, multiple core, or include more than one processing elements. The processor 920 can be disposed on silicon or any other suitable material. The processor 920 can receive and execute instructions and data stored in the memory 910 or the storage drive 930

The storage drive 930 can be any non-volatile type of storage such as a magnetic disc, EEPROM, Flash, or the like. The storage drive 930 stores code and data for applications.

The I/O port 940 further comprises a user interface 942 and a network interface 944. The user interface 942 can output to a display device and receive input from, for example, a keyboard. The network interface 944 (e.g. RF antennae) connects to a medium such as Ethernet or Wi-Fi for data input and output.

Many of the functionalities described herein can be implemented with computer software, computer hardware, or a combination.

Computer software products (e.g., non-transitory computer products storing source code) may be written in any of various suitable programming languages, such as C, C++, C#, Oracle® Java, JavaScript, PHP, Python, Perl, Ruby, AJAX, and Adobe® Flash®. The computer software product may be an independent application with data input and data display modules. Alternatively, the computer software products may be classes that are instantiated as distributed objects. The computer software products may also be component software such as Java Beans (from Sun Microsystems) or Enterprise Java Beans (EJB from Sun Microsystems).

Furthermore, the computer that is running the previously mentioned computer software may be connected to a network and may interface to other computers using this network. The network may be on an intranet or the Internet, among others. The network may be a wired network (e.g., using copper), telephone network, packet network, an optical network (e.g., using optical fiber), or a wireless network, or any combination of these. For example, data and other information may be passed between the computer and components (or steps) of a system of the invention using a wireless network using a protocol such as Wi-Fi (IEEE standards 802.11, 802.11a, 802.11b, 802.11e, 802.11g, 802.11i, 802.11n, and 802.11 ac, just to name a few examples). For example, signals from a computer may be transferred, at least in part, wirelessly to components or other computers.

In an embodiment, with a Web browser executing on a computer workstation system, a user accesses a system on the World Wide Web (WWW) through a network such as the Internet. The Web browser is used to download web pages or other content in various formats including HTML, XML, text, PDF, and postscript, and may be used to upload information to other parts of the system. The Web browser may use uniform resource identifiers (URLs) to identify resources on the Web and hypertext transfer protocol (HTTP) in transferring files on the Web.

This description of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications. This description will enable others skilled in the art to best utilize and practice the invention in various embodiments and with various modifications as are suited to a particular use. The scope of the invention is defined by the following claims.

I claim:

1. A computer-implemented method in a network infrastructure device in a communication network for remote management, the method comprising the steps of:
receiving a message on an instant messenger application executing on the network infrastructure device, the message sent from an authorized party;
map the message to one or more commands recognized by an operating system of the network infrastructure;
submitting the one or more commands on a command line interface;
receiving a response to the one or more commands from the network infrastructure device on the command line interface;
sending the response on the instant messenger application to the authorized party.

2. The method of claim 1, wherein the authorized party that sent the instant message comprises a second network infrastructure device.

3. The method of claim 1, wherein the receiving the message comprises receiving a natural language message on the instant messenger application executing on the network infrastructure device, and wherein mapping the message comprises mapping the natural language message to one the one or more commands recognized by the operating system of the network infrastructure.

4. The method of claim 3, further comprising:
mapping the response to a natural language message,
wherein sending the response comprises sending the natural language message on the instant messenger application

5. The method of claim 1, further comprising:
prior to receiving the message, authorizing the authorized party for sending messages to the instant messenger application.

6. The method of claim 1, further comprising:
receiving a second message on the instant messenger application from an second authorized party; and
sending a second response on the instant messenger application to the second authorized party, without sending the response to the authorized party.

7. The method of claim 1, wherein the network infrastructure device comprises at least one or a controller and an access point.

8. A non-transitory computer readable medium storing source code that, when executed by a processor, performs a method in in a network infrastructure device in a communication network for remote management, the method comprising the steps of:
receiving a message on an instant messenger application executing on the network infrastructure device, the message sent from an authorized party;
map the message to one or more commands recognized by an operating system of the network infrastructure;
submitting the one or more commands on a command line interface;
receiving a response to the one or more commands from the network infrastructure device on the command line interface;
sending the response on the instant messenger application to the authorized party.

9. The computer readable medium of claim 8, wherein in the method, the authorized party that sent the instant message comprises a second network infrastructure device.

10. The computer readable medium of claim 8, wherein in the method, the receiving the message comprises receiving a natural language message on the instant messenger application executing on the network infrastructure device, and wherein mapping the message comprises mapping the natural language message to one the one or more commands recognized by the operating system of the network infrastructure.

11. The computer readable medium of claim 8, the method further comprises:
mapping the response to a natural language message,
wherein sending the response comprises sending the natural language message on the instant messenger application

12. The computer readable medium of claim 8, the method further comprises:
prior to receiving the message, authorizing the authorized party for sending messages to the instant messenger application.

13. The computer readable medium of claim 8, the method further comprises:
receiving a second message on the instant messenger application from an second authorized party; and
sending a second response on the instant messenger application to the second authorized party, without sending the response to the authorized party.

14. The computer readable medium of claim 8, wherein in the method, the network infrastructure device comprises at least one or a controller and an access point.

15. A network infrastructure device in a communication network for remote management, the network infrastructure device comprising:
a processor;
a memory, comprising:
a first module to receive a message on an instant messenger application executing on the network infrastructure device, the message sent from an authorized party;
a second module to map the message to one or more commands recognized by an operating system of the network infrastructure;
a third module to submit the one or more commands on a command line interface;
a fourth module to receive a response to the one or more commands from the network infrastructure device on the command line interface;
a fifth module to send the response on the instant messenger application to the authorized party.
